(19) United States
(12) Patent Application Publication
(10) Pub. No.: US 2024/0261164 A1
(43) Pub. Date: Aug. 8, 2024

(54) MOBILE SURGICAL UNIT

(71) Applicant: THE TEXAS A&M UNIVERSITY SYSTEM, College Station, TX (US)

(72) Inventors: Brayden RAPER, College Station, TX (US); Neil Koby REID, College Station, TX (US); Jacob PARIS, College Station, TX (US); William HENDRICKS, College Station, TX (US)

(21) Appl. No.: 18/435,506

(22) Filed: Feb. 7, 2024

Related U.S. Application Data
(60) Provisional application No. 63/443,780, filed on Feb. 7, 2023.

(51) Int. Cl. A61G 10/00

(52) U.S. Cl. CPC A61G 10/005

(57) ABSTRACT

The present disclosure provides systems and methods for the benefit of surgical procedures in such austere locations. As described herein, the technology is applicable anywhere in the world where access to medical care is limited or not available but necessary, especially more than one hour away by transport. These applications include space, military field medicine, recreational wilderness medicine, sites of disasters (e.g., earthquakes, tsunamis, building collapses, etc.), healthcare in rural or underdeveloped locations, and hospitals or clinics with resource shortages or limitations.

### CROSS-REFERENCE TO RELATED APPLICATIONS

This application claims the benefit under 35 U.S.C. § 119(e) of U.S. Provisional Application Ser. No. 63/443,780, filed on Feb. 7, 2023, the entire disclosures of which is incorporated herein by reference.

### BACKGROUND AND SUMMARY

The number of humans working in extreme wilderness conditions has grown substantially over the past century. Submariners, explorers, military personnel, and astronauts are four large groups that routinely live in extremely high risk environments with long emergency medical extraction times ranging from days to years. Predictive models and documented cases have demonstrated that invasive procedures in these populations vary greatly in frequency, as they are common in military combat yet extremely rare in spaceflight. However, when invasive procedures do occur, they can be catastrophic in terms of survival and mission success.

The health risks in these environments include both unpredictable common medical emergencies and traumas. Common procedures include the insertion of chest tubes, laceration repairs, wound debridement, fracture reduction, damage control surgery, limb amputations, and basic general surgery procedures such as appendectomy and cholecystectomy. Certain medical procedures for trauma and wound care will likely be required in austere locations, such as a forward operating base where no emergency medical transport is available.

However, current instances of these procedures are regularly performed in an extremely unsafe manner relative to the luxuries of a hospital environment. For instance, in military and wilderness medicine, very limited medical kits are available that are constrained by the weight restrictions of personnel. This leads to a high rate of post-procedural complications including infection and death. Moreover, the problems that exist in an austere wilderness environment on Earth are more severe when they occur in space. Accordingly, there exists a need to create a portable and reusable set of medical tools and equipment that can be rapidly deployed to conduct surgical interventions in austere locations to reduce the risk of death, permanent injury, and mission failure.

Accordingly, the present disclosure provides systems and methods for the benefit of surgical procedures in such austere locations. The systems and methods of the present disclosure provide several benefits compared to the current state of the art. For example, the systems are compact and portable. Moreover, the technology is applicable anywhere in the world where access to medical care is limited or not available but necessary, especially more than one hour away by transport. These applications include military field medicine, recreational wilderness medicine, sites of disasters (e.g., earthquakes, tsunamis, building collapses, etc.), healthcare in rural or underdeveloped locations, and hospitals or clinics with resource shortages or limitations. Finally, the unique features of the present disclosure can solve many of the identified problems wilderness and military applications as well as spaceflight applications.

Other objects, features and advantages of the present disclosure will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTIONS OF THE DRAWINGS

The detailed description particularly refers to the accompanying figures in which:

FIG. 1 shows the surgical system of the present disclosure, comprising a theater bubble, a retractor case, and an operating tent.

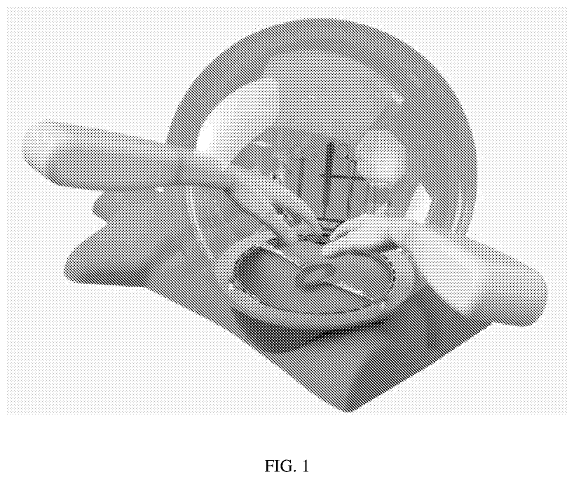

FIG. 2 shows an exemplary mechanism of attachment between components using magnetic rings.

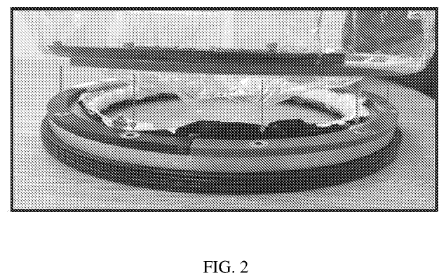

FIGS. 3A and 3B show a retractor ring in collapsed form with telescoping retractors.

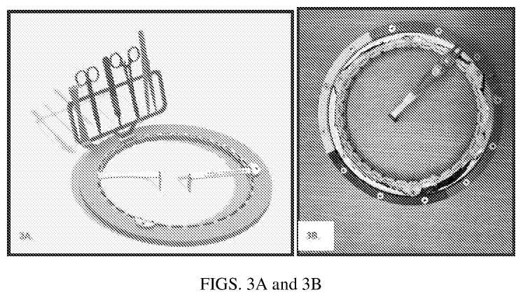

FIG. 4 shows an exemplary ring in closed position (upper) and in expanded position (lower).

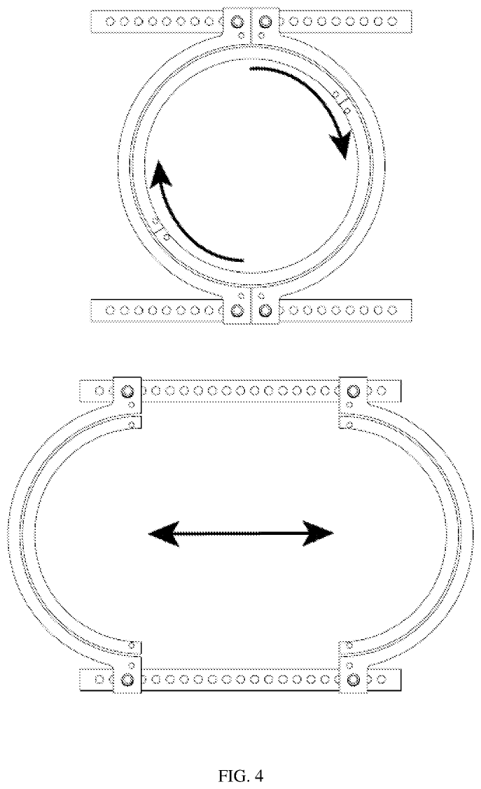

FIG. 5 shows an embodiment of an operating tent for use on an object with a large surface (e.g., abdomen, back, etc. of a patient).

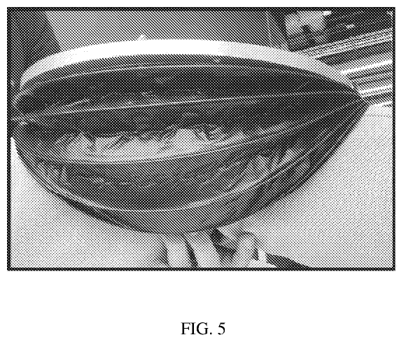

FIG. 6 shows the internal schematics for an embodiment of an operating tent for use on an appendage or extremity of a patient.

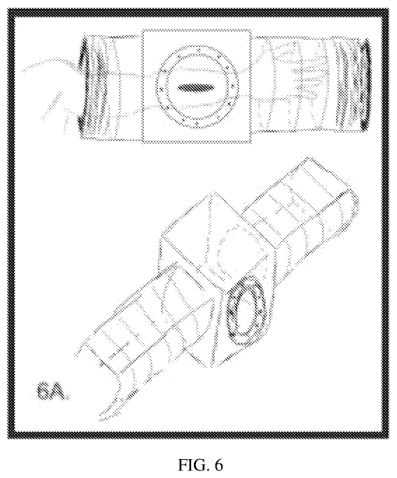

FIG. 7 shows an embodiment of a telescoping retractor that is adjustable via a middle portion that does not extend past the distal end or the proximal end.

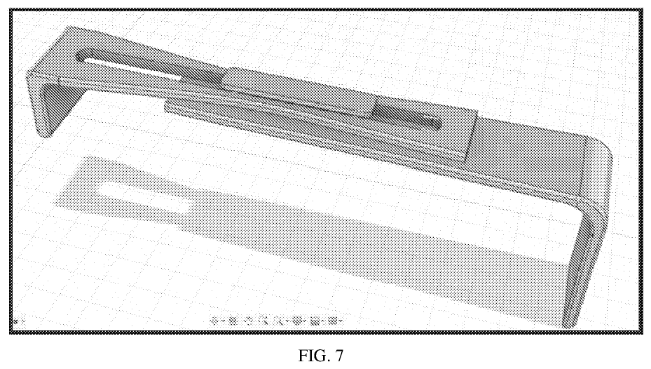

FIGS. 8A and 8B show an embodiment of a telescoping retractor at its full length (FIG. 8A) and at a shorter, adapted length (FIG. 8B).

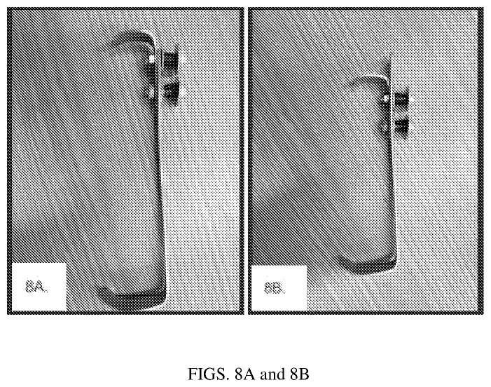

FIG. 9 shows an exemplary suction tool integrated into a traditional hemostat.

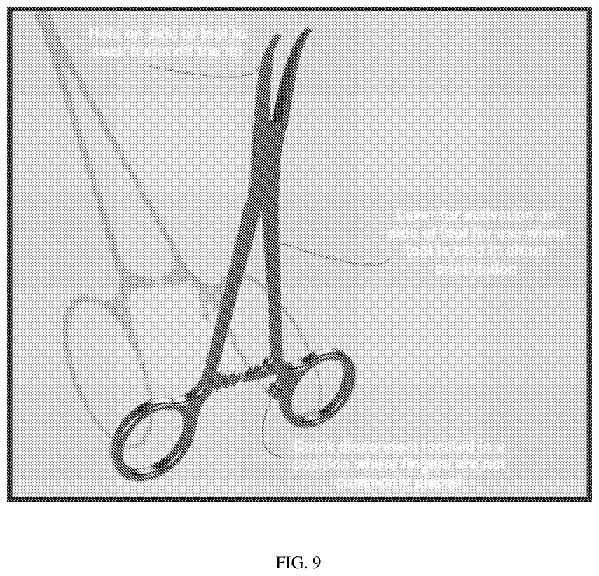

FIG. 10 shows a cross section of an exemplary lever suction apparatus.

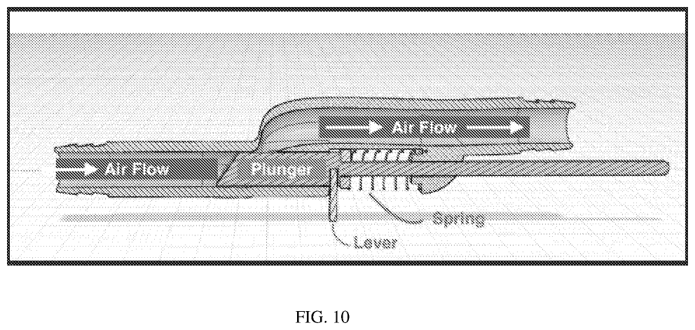

FIG. 11 shows an exemplary method of using the surgical system in space.

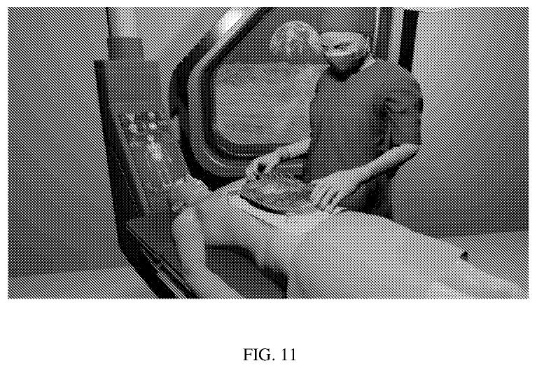

FIG. 12 shows a closer view of the exemplary method of using the surgical system in space.

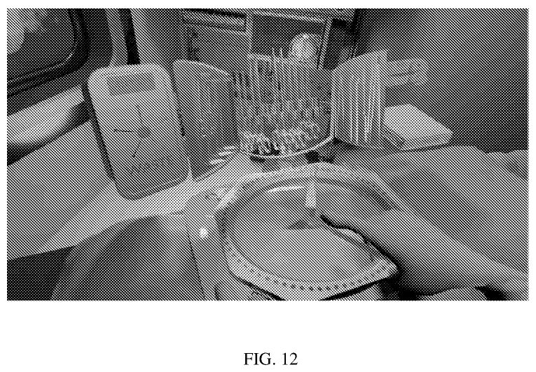

### DETAILED DESCRIPTION

Various embodiments of the invention are described herein as follows. In an illustrative aspect, a retractor apparatus comprising one or more retractors is provided.

In an embodiment, the retractor comprises one or more retractable arms. In an embodiment, the retractable arm is configured to hold tissue of a patient within a surgical site. In an embodiment, the retractable arm is configured to manipulate tissue of a patient within a surgical site. In an embodiment, the retractable arm is configured to hold an organ of a patient within a surgical site. In an embodiment, the retractable arm is configured to manipulate an organ of a patient within a surgical site.

In an embodiment, the retractor is a telescoping retractor. In an embodiment, the retractor comprises a spring loaded mechanism. In an embodiment, the retractor comprises an interchangeable head.

In an embodiment, the retractor comprises a distal end, a proximal end, and a middle portion between the distal end and the proximal end. In an embodiment, the middle portion is adjustable so that it does not extend past the distal end or the proximal end. In an embodiment, the distal end is rigid. In an embodiment, the distal end comprises a metal, a polymer, or a combination thereof. In an embodiment, the distal end is malleable. In an embodiment, the distal end is shaped. The malleable nature of the retraction should be malleable enough that it can be bent and shaped with enough force, but retain at least enough tensile strength to maintain most of its shape while retracting tissue.

In an embodiment, the retractor comprises a proximal end comprising a connection composition. In an embodiment, the connection composition is configured for attachment to a ring. In an embodiment, the ring is present on a retractor case. In an embodiment, the retractor comprises a suture retractor configured to couple with the ring. In an embodiment, the connection composition is configured for attachment to the ring via the bottom portion of the ring. In an embodiment, the connection composition is configured for engagement and disengagement from the ring.

In an embodiment, the connection composition comprises a peg. In an embodiment, the connection composition comprises a rod. In an embodiment, the connection composition comprises a notch. In an embodiment, the connection composition comprises a clip. In an embodiment, the connection composition comprises a locking mechanism.

In an embodiment, the connection composition is configured for coupling via mechanical means, electrical means, magnetic means, or any combination thereof. In an embodiment, the connection composition is configured for coupling via mechanical means. In an embodiment, the connection composition is configured for coupling via electrical means. In an embodiment, the connection composition is configured for coupling via magnetic means. In an embodiment, the magnetic means comprise one or more static magnets. In an embodiment, the magnetic means comprise electromagnetic energy. In an embodiment, the electromagnetic energy comprises use of an electrical current.

In an embodiment, the retractor comprises a distal end locking mechanism. In an embodiment, the retractor comprises an engaging composition to control the distal end locking mechanism. In an embodiment, the engaging composition comprises a button, a switch, a grip, or any combination thereof.

In an embodiment, the retractor is configured for movement using one hand of an operator. The retractor mechanism may be set by first hooking, retracting and otherwise putting tension on the tissue and then locking to the ring of the retractor case. In other embodiments, the retractor may be set and locked to the ring of the retractor case first, disengaged from its locking mechanism so that its distal end can be maneuvered, applied to the tissue of interest to maintain retraction, and engaged to its locking mechanism. In both instances, the retractor may be placed, set and locked in place by the operator using only one hand.

In an embodiment, the retractor is configured for movement using two hands of an operator. In an embodiment, the retractor comprises a handle, a grip, or a combination thereof. In an embodiment, the handle and/or the grip is placed on the superior portion of the distal end of the retractor.

In an embodiment, the retractor comprises one or more degrees of freedom. In an embodiment, the retractor comprises one degree of freedom. In an embodiment, the retractor comprises two degrees of freedom. In an embodiment, the retractor comprises three degrees of freedom. In an embodiment, the retractor comprises four degrees of freedom. In an embodiment, the retractor comprises five degrees of freedom. In an embodiment, the retractor comprises six degrees of freedom. In an embodiment, the retractor comprises six or more degrees of freedom.

The following modes of retraction may be used in addition to the retraction modalities described above or in combination with those described above. An Army-Navy retractor utilizes a 90 degree bend in a flat metal plate at its distal end that hooks tissue to achieve retraction where a Gelpi retractor uses angled points or hooks on its distal end that dig into tissue to maintain tension. In the retractor modalities described above, each distal facing retractor may have a single, static shape by which retraction is achieved. In other embodiments, this distal tissue facing portion may be modular. In the instance that the retractor has a modular distal end, the handle, locking mechanism and coupling mechanism used to attach the ring of the retractor case may be the same, but each retractor may have a clip, slot or other attachment mechanism to swap different tissue facing portions. Each retractor with a different distal tissue facing component is used for different purposes, as each has a different length (portion extended from the same plane as a handle, parallel to a patient lying supine) and depth (length extended at 90 degrees from the plane of the handle towards the posterior aspect of a patient lying supine). The modular design of the retractor would not only allow for different types of tissue retraction (flat, blunt retraction from an Army-Navy versus focused, sharp retraction from a Gelpi) for different types of tissue, but also different lengths and depths, for retraction of deep and superficial tissue, using the same retractor handle.

In an embodiment, the retractor comprises soft robotics. In an embodiment, the retractor comprises one or more cable driven joints. In an embodiment, the retractor comprises one or more spring mechanisms. In an embodiment, the retractor comprises one or more rack and pinion compositions. In an embodiment, the retractor comprises one or more electromagnetic mechanisms.

In an embodiment, the retractor comprises one or more electrical mechanisms. In an embodiment, the retractor comprises an electrical locking mechanism capable of engaging and/or disengaging the position of the retractor. In the instance where the retractor contains a metal, polymer, or combination of the two or other material that is rigid in the presence of electrical current and malleable in its absence, or vice versa, the modification of electrical current may allow some embodiments of the retractor to be moved in 3D space while still retaining its relative position in 3D space once the operator no longer wants it to be moved

In an embodiment, the retractor comprises one or more buttons to engage and/or disengage movement in isolated planes. In an embodiment, the retractor comprises one or more switches to engage and/or disengage movement in isolated planes. In an embodiment, the retractor comprises one or more locking mechanisms to engage and/or disengage movement in isolated planes.

In an embodiment, the retractor comprises one or more grips. In an embodiment, the grips comprise material for increasing coefficient of friction.

In an embodiment, the retractor comprises one or more intervals configured to comprise suture material. In an embodiment, the interval comprises a mechanism configured to hold the suture material. Operators often require an assistant to hold tension on sutures to retract tissue, to aid in the tying of knots, or for many other means. In an embodiment, the mechanism comprises means for holding selected from the group consisting of a clamp, a notch, friction, and any combination thereof. This “stand-alone” suture retractor would allow flexibility in placement around the ring of the retractor case and may or may not be dependent on the placement of the other tissue retractors in the field.

In an illustrative aspect, a retractor case comprising an inner ring, an outer ring, and one or more surgical instruments is provided.

In an embodiment, the retractor case is configured to contact to a theater bubble. In an embodiment, the contact between the retractor case and the theater bubble is an airtight seal. In an embodiment, the contact is via a magnetic interaction. In an embodiment, the contact is via the inner ring. In an embodiment, the contact is via the outer ring.

In an embodiment, the retractor case is configured to contact to an operating tent. In an embodiment, the contact between the retractor case and the operating tent is an airtight seal. In an embodiment, the contact is via a magnetic interaction. In an embodiment, the contact is via the inner ring. In an embodiment, the contact is via the outer ring.

In an embodiment, the inner ring is configured for 360 degree rotation. In an embodiment, the inner ring is configured for placement of one or more retractor apparatuses. In an embodiment, the retractor apparatus is the retractor apparatus of any embodiment described herein. In an embodiment, the configuration comprises one or more notches.

In an embodiment, the inner ring is configured for connection to a strap. In an embodiment, the strap comprises one or more buckles. In an embodiment, the inner ring comprises one or more holes or pegs configured to connect to the strap via one or more buckles. In an embodiment, the strap is an electrosurgery ground pad. In an embodiment, the strap is an electrocautery ground pad. In an embodiment, the outer ring is configured for 360 degree rotation.

In an embodiment, the outer ring is configured for connection to a strap. In an embodiment, the strap comprises one or more buckles. In an embodiment, the inner ring comprises one or more holes or pegs configured to connect to the strap via one or more buckles. In an embodiment, the strap is an electrosurgery ground pad. In an embodiment, the strap is an electrocautery ground pad. case may have electrical leads, pads, or other that interface with the patient to ground the electrically powered device or otherwise provide a complete circuit in order for the adequate function of such electrical devices.

In an embodiment, the inner ring, the outer ring, or both are electrically powered. In an embodiment, the electric power comprises a battery. In an embodiment, the electric power comprises a rechargeable battery. In an embodiment, the electric power comprises a portable battery. In an embodiment, the electric power comprises a car battery. In an embodiment, the electric power comprises a connection to a 120 volt outlet. In an embodiment, the electric power comprises a connection to a 220 volt outlet. In an embodiment, the electric power comprises a connection to a 240 volt outlet. Each embodiment with different mechanisms of electrical power can either be individually connected, or can have a combination of the inputs described above.

In an embodiment, the electric power comprises a single circuit. In an embodiment, the electric power comprises a multi-circuit. In an embodiment, the inner ring and/or the outer ring comprises an inferior portion comprising an interface for grounding. In an embodiment, the interface comprises an electric lead. In an embodiment, the interface comprises a pad. In embodiments of the retractor case that include electrical power, there may be a single circuit, or many circuits, embedded into the ring of the retractor case capable of transmitting and storing energy. There may be leads, connectors, or other mechanical mechanisms of connection electrical power from the ring to attachments, embedded within connection points of the ring of the retractor case. With such a mechanism, an electrical powered retractor, light, suction device, electrosurgery, electrocautery or other, may be coupled to the ring of the retractor case and be supplied with electrical power.

In an embodiment, the inner ring, the outer ring, or both are optionally sealed with a lid. In an embodiment, the lid comprises a metal, a polymer, or a combination thereof. Some embodiments can be single use or reusable. Certain embodiments can utilize the existing attachment points on the ring of the retractor case as a mechanism of attachment, but may attach in other ways. In situations where there are already retractors, or tools connected to the ring, the embodiments of the lid may attach onto or around these components. The lid may also attach onto or around the display system to keep the tools protected from the ambient environment in addition to the surgical field. Such a lid can be easily removed and stored such that surgery may be promptly resumed.

In an embodiment, the retractor case comprises a container for inclusion of the inner ring, the outer ring, and the surgical instruments. In an embodiment, the container comprises a top portion that is sealable. In an embodiment, the container comprises a bottom portion that is sealable. In an embodiment, the container is air-tight. In an embodiment, the container is configured for sterilization of the surgical instruments.

In an embodiment, the container comprises a lumen. In an embodiment, the lumen is configured for injection of a sterilizing fluid. In an embodiment, the sterilizing fluid comprises a liquid comprising tetraglycine hydroperiodide tablets, trichloroisocyanuric acid tablets, chlorine dioxide tablets, a liquid comprising iodine tablets, a betadine solution, a chlorhexidine solution, or any combination thereof.

In an embodiment, the container comprises a suction mechanism. In an embodiment, the container comprises a fluid removal mechanism. In an embodiment, the retractor case is capable of 360 degree rotation.

In an embodiment, the retractor case is capable of expansion into an ellipse shape. In an embodiment, the retractor case is configured for collapse.

In an embodiment, the retractor case is configured for housing within an external holding device. In an embodiment, the external holding device is a casing. In an embodiment, the external holding device is a bag. In an embodiment, the external holding device comprises air-tight sealing of the retractor case. Such air-tight sealing can be used, for instance, as primary sterilization on initial manufacturing. In an embodiment, the external holding device is configured for primary sterilization.

In an embodiment, the external holding device is resealable. The external holding device may be resealable to allow for sterilization of the system components mentioned previously after an initial deployment and use of the system, using either chemical, thermal, electrical or electromagnetic radiation that incorporates wavelengths, such as UV, IR, X-ray, Gamma, or other sterilization techniques. This external holding device described above may have the mechanical properties such that it can be sterilized with being damaged or modified. This embodiment may be sterilized through commercial methods and may be further sterilized, sanitized, or otherwise cleaned through the mechanisms described above for additional uses.

In an embodiment, the external holding device is capable of one or more cycles of sterilization. In an embodiment, the sterilization comprises chemical sterilization, thermal sterilization, electrical sterilization, electromagnetic, radiation sterilization, UV sterilization, IR sterilization, X-ray sterilization, Gamma sterilization, or any combination thereof.

In some embodiments, the retractor case includes a single ring that contains 360 degree ability for retraction without rotation of the apparatus. The ring can include holes or pegs that allow for implementation of a variety of different tools, from retractors, light apparatuses, display cases, suture holders, and other implementable devices.

In an embodiment, the retractor case comprises a film positioned between the inner ring and the outer ring. In an embodiment, the film overlays a procedural field of the retractor case. In an embodiment, the film is adhesive. In an embodiment, the film is sterilized. In an embodiment, the film comprises a sterilizing agent. In an embodiment, the sterilizing agent is betadine. In an embodiment, the film is configured to be adhered to skin. In an embodiment, the film is configured to be perforated.

In an embodiment, the retractor case further comprises a strap. For instance, the strap can adhere one or more components to a patient. In an embodiment, the strap comprises one or more buckles. In an embodiment, the strap is configured to connect to the inner ring or the outer ring. In an embodiment, the strap is an electrosurgery ground pad. In an embodiment, the strap is an electrocautery ground pad.

A strap can assist with adherence to the patient, and minimizes or negates the need for stabilization to any external apparatus, such as a table or frame.

The use of adhesive and patient straps render retractor system unique and different from other retractor systems known in the art, such as straps that must be attached to the bed/table or that use opposing traction forces to provide stability. As described herein, the component is capable of securely attaching to the patient and allows unilateral retraction without requiring balancing forces.

In austere environments, limb fractures may provide difficult situations to address without a fully equipped operating room. In some embodiments, the separate pieces of the ring of the retractor case expand to create an external fixation apparatus for limb fractures. The retractor case may stabilize the limb through pins or other external connections connected to the ring through the holes or pegs throughout the apparatus, or directly to the apparatus itself.

In an embodiment, the retractor case comprises latex. In an embodiment, the retractor case comprises a thin elastic material, for instance in the shape of a cylinder. When rolled within itself from one end of the cylinder towards the opposite end, the components may allow for retraction of the superficial and/or deep components of the patient.

In an embodiment, the retractor case comprises one or more lights. In an embodiment, the light is a LED light. In an embodiment, the light is battery powered. Additionally, light booms maybe placed in the retractor connectors, directly onto the surface of the retractor case, to the adhering mechanisms such as the straps, or other connection apparatuses to provide overhead light.

In an embodiment, the light is coupled to the inner ring. In an embodiment, the light is coupled to the outer ring. These embodiments may utilize individual batteries to power the lights or they may be connected together or to a single battery.

The retractor case, alone or combined with embodiments of the operating tent can provide usefulness in austere surgical settings. This component or combination can comprise necessary surgical instruments needed to perform the required procedures in a contained and reduced manner. A reduction in the number of surgical instruments from a standard instrument set can be achieved in order to avoid redundancy from the standard instrument set that is not required for a surgical. Surgical instrument storage during surgery can require unique requirements that are different from the operating room, as such surgical instruments cannot simply be placed on a table or tray. The surgical instruments may be attached to the components with clips, magnets, Velcro, or rings. The surgical instruments can collapse over each other when the retractor case closed and can fan out to be easily accessed during the procedure. The surgical instruments may be color coded into zones to help facilitate tool storage, attachment mechanisms, and speed of retrieval. The retractor case can include a “display system” that folds within the system and uses hinges to expand and display surgical instruments

In an embodiment, the retractor case comprises a display system. In an embodiment, the display system is configured to integrate into one or more holes or pegs in the retractor case. In an embodiment, the display system comprises a mechanical system comprising a clip, a magnet, Velcro, a ring, or any combination thereof. In an embodiment, the mechanical system is configured to hold one or more surgical instruments to the base of the display system.

In an embodiment, the display system comprises one or more storage rings. In an embodiment, the storage ring is placed on an edge of the display system. In an embodiment, the storage ring is placed on a corner of the display system. In an embodiment, the storage ring is placed on the top of the display system. In an embodiment, the storage ring is placed on the bottom of the display system.

In an embodiment, the display system comprises the one or more surgical instruments. In an embodiment, the surgical instruments are selected from the group consisting of scalpels, individual scalpel blades, scissors, clamps, forceps, retractors, and any combination thereof. In an embodiment, the display system is configured for rotation around the inner ring or the outer ring of the retractor case.

Further, the display system may be moved or rotated around the ring of the retractor case so that visibility can be maintained and modified by the operator as needed. There may be locking mechanisms (e.g., mechanical, magnetic, electrical or other) so that the position of the display system position can be adjusted but will remain in place when the operator is no longer actively moving it. This ability of adjustment can apply to its relative position to the circumference around the ring of the retractor case, but also applies to the relative angle of positioning to the patient. For example, the display system can stand upright, perpendicular to the plane of the patient lying supine, or maneuvered on a hinge or other mechanism in order to lie parallel to the plane of the patient lying supine. The position relative to the patient lying supine can be modified around an axis set at the point of the ring of the retractor case or other from 0 degrees to 180 degrees.

The retractor case can be lightweight, packable, provide sterile storage and organization of surgical instruments and tools. Further, the retractor case can provide a low cost and expedited sterilization of instruments through a fluid-based chemical method with the capability of optionally including a sonicator in the field. This is important because field medical personnel rarely have access to soap and water, and almost never have access to standard sterilization methods such as an autoclave.

In an illustrative aspect, a surgical system comprising i) a theater bubble, ii) a retractor case, and iii) an operating tent is provided.

In an embodiment, the theater bubble comprises between 2 and 6 operator openings. In an embodiment, the operator openings are configured for insertion of hands of an operator. In an embodiment, the operator openings are configured for insertion of arms of an operator. In an embodiment, the operator openings are configured for insertion of a tool. In an embodiment, the tool is an electrical tool. In an embodiment, the tool is a suction tool. In an embodiment, the operator openings are sealable.

In an embodiment, the retractor case is the retractor case of any one the embodiments described herein.

In an embodiment, the operating tent comprises a clear tent. In an embodiment, the operating tent is configured to provide an air-tight seal between the retractor case and a patient body to form a surgical operating site. In an embodiment, the operating tent comprises a magnetic connecting ring to contact the retractor case. In an embodiment, the operating tent comprises an adhesive to contact to a patient body.

In an embodiment, the operating tent comprises a flexible material. In an embodiment, the operating tent comprises a magnetic connecting ring to contact the retractor case. In an embodiment, the operating tent comprises an adhesive to contact to a patient appendage. Such embodiment, for instance, can be utilized for use on limbs and extremities, as these injuries are anticipated to be common during spaceflight.

In an embodiment, the operating tent comprises collapsible tubing. In an embodiment, the collapsible tubing comprises a first end and a second end. In an embodiment, the first end is sealed. In an embodiment, the second end is configured for insertion of a patient appendage.

An operating tent can be a box, for instance, that can include collapsible tubing on either side, large enough to insert an arm or leg. One end can be sealed and the other end can be opened so the patient can place the limb inside. The purpose of the collapsable tubing is so that any site of the limb, be it the most distal or most proximal end, can be centered within the box connected to the retractor case. The collapsible nature on either end gives the operator the flexibility of placing the retractor case on the limb at a desired location.

In an embodiment, the theater bubble is configured to contact to the retractor case. In an embodiment, the contact between the retractor case and the theater bubble is an airtight seal. In an embodiment, the contact is via a magnetic interaction. In an embodiment, the contact is via an inner ring of the retractor case. In an embodiment, the contact is via an outer ring of the retractor case.

In an embodiment, the operating tent is configured to contact to the retractor case. In an embodiment, the contact between the retractor case and the operating tent is an airtight seal. In an embodiment, the contact is via a magnetic interaction. In an embodiment, the contact is via an inner ring of the retractor case. In an embodiment, the contact is via an outer ring of the retractor case.

In an illustrative aspect, a method of performing a surgical intervention on a patient is provided. The method comprises use of one or more of i) a theater bubble, ii) a retractor case, and iii) an operating tent on the patient, In an embodiment, the surgical intervention is performed in an austere location.

In an embodiment, the i) a theater bubble, ii) a retractor case, and iii) an operating tent are comprised as the surgical system of any embodiment described herein.

In an embodiment, the austere location is a military location. In an embodiment, the austere location is a recreational wilderness medicine location. In an embodiment, the austere location is a disaster location. In an embodiment, the austere location is a rural location. In an embodiment, the austere location is in space.

The embodiments described herein can be adapted to incorporate a surgical suction component. For instance, surgical suction can be incorporated into surgical instruments or tools including, but not limited to, hemostats, scissors, forceps, or scalpels. The tools can comprise a built-in suction path with a mechanical apparatus for turning the suction on and off without the need for electricity. The mechanical apparatus controlling the suction can modulate the suction pump by controlling pressures in the system that can be fed back into the suction pump controller. Further, the mechanical apparatus can also contain a magnetic or mechanical quick disconnect apparatus.

Alternatively, incorporation of hand suction can be included in the system via attachment of a suction catheter to the tip of the operator's fingers using straps, clips, or elastic bands. Some embodiments may include a clip, Velcro, or other attachment in which the tip of the suction device or tubing can be temporarily attached to the operator. In doing so, the operator may be able to control the direction of suction without holding it within a hand.

A sterilization bag can also be used as a suction mechanism when power is not available. for instance, the sterilization bag can provide a negative pressure reservoir to allow suction capabilities for the surgical field. Afterwards, it can be drained, rinsed, and used for system sterilization.

In some embodiments, the external holding device may include an internal mechanism through stands, expandable rings, or a combination thereof that allow for the creation of negative pressure within a sealed system, when activated. This negative pressure can be attached to a suction tool, tubing, or a combination of both to allow for the creation of an electrically-independent, negative pressure suction device for use during procedures.

The external compression device may include use of two one-way valve mechanisms—one at the proximal end, directly connected to the suction device, tubing or combination of both in order to minimize or negate retrograde flow of suctioned materials and a second at the distal end to allow for external manual compression of the system to dispel the suctioned contents from the external holding device. After manual compression, the external holding device will be subjected to negative pressure again from the apparatus mentioned previously and allow for continuous suction.

The suction device can comprise a rigid plastic, metal, polymer, or a combination thereof that connects to the external holding device to allow for manual suction during a procedure. The suction device may contain a button, switch, trigger, or alternative mechanism to alter between a suctioning state and an enclosed, negative pressure “holding state”. During the holding state, the suction device may have a movable valve, entrapment, compression, or other mechanism to separate the negative pressure from the distal, working end of the suction device in order to maintain the negative pressure within the external holding device. During the suctioning state, the mechanism can be altered in a way that allows negative pressure suction throughout the entire suction device, expelling the suctioned contents through a one-way valve into the external holding device.

Liquid irrigation is an important aspect of any surgical procedure, in order to wash, wet or otherwise moisten an area of interest. This is often accomplished with sterile saline or chemical solutions. Some embodiments may incorporate a modality of irrigation that is similar to or the reverse of the suction modalities described above. In this instance, a container can comprise a rigid plastic, metal, polymer, or a combination thereof that connects to an external holding device. Such a container can comprise a mechanism by which it can resist compression.

Some embodiments may include a one-way valve to provide for the introduction of air into the system each time it is compressed to maintain a desired volume in order to maintain a desired positive pressure. Such a container can be filled with a solution of interest and when pressure is applied to the container, external forces can compress the container such that it pushes the solution through the holding device and into the operating field. Optionally, a one-way valve can be included between the holding device or tubing connecting to the container to prevent the accidental contamination of solution, or movement of fluid in an undesired direction. Some embodiments of this component may include a way to refill the container during a procedure upon it emptying. Such embodiments may incorporate a filter or another mechanism by which to ensure the lumen of the container is not contaminated by the ambient air or other fluid.

Surgical instruments as described herein can include a handle similar to a standard scalpel made of a hard plastic, a metal, a polymer, or a combination thereof that provides for connection to a variety of separate scalpel blades that are housed within the system. A device can comprise a storage container that houses the scalpel blades. The storage container can include a switch, gear, pin or other mechanism that allows for hands-free ejection of the current scalpel blade that is connected to the handle. The storage container can comprise a switch, gear, pin or other mechanism that allows for hands free reintegration of a unused, sharp scalpel blade onto the handle. This mechanism allows for hands-free usage of multiple scalpel blades, eliminating the necessity of using other instruments such as forceps, hemostats, or other instruments as well as a first assist to change scalpel blades when they are dull.

Other embodiments can comprise indentions, compartments, housings or other mechanisms within the display system that house different needles and sutures of many varieties. These sutures may be housed directly within the display system, behind the display system, or on the edges or other areas of the display system that provide effective storage of the sutures. The needles in which the sutures are connected to may be housed individually within the display system and be deployable with the other tools, thus providing for an operator to easily identify the suture of choice and quickly access it without the need of assistance from a first-assist.

In other embodiments, a set of latex, nitrile or other gloves impregnated with betadine, chlorhexidine, or other chemical sanitization may be included within the system. This allows for the gloves to not only be a physical border between the patient and the user, but also allows for anti-microbial activity to potentially decrease the amount of microbial activity and transmission during the procedure.

The following numbered embodiments are contemplated and are non-limiting:
1. A retractor apparatus comprising one or more retractors.
2. The retractor apparatus of clause 1, any other suitable clause, or any combination of suitable clauses, wherein the retractor comprises one or more retractable arms.
3. The retractor apparatus of clause 2, any other suitable clause, or any combination of suitable clauses, wherein the retractable arm is configured to hold tissue of a patient within a surgical site.
4. The retractor apparatus of clause 2, any other suitable clause, or any combination of suitable clauses, wherein the retractable arm is configured to manipulate tissue of a patient within a surgical site.
5. The retractor apparatus of clause 2, any other suitable clause, or any combination of suitable clauses, wherein the retractable arm is configured to hold an organ of a patient within a surgical site.
6. The retractor apparatus of clause 2, any other suitable clause, or any combination of suitable clauses, wherein the retractable arm is configured to manipulate an organ of a patient within a surgical site.
7. The retractor apparatus of clause 1, any other suitable clause, or any combination of suitable clauses, wherein the retractor is a telescoping retractor.
8. The retractor apparatus of clause 1, any other suitable clause, or any combination of suitable clauses, wherein the retractor comprises a spring loaded mechanism.
9. The retractor apparatus of clause 1, any other suitable clause, or any combination of suitable clauses, wherein the retractor comprises an interchangeable head.
10. The retractor apparatus of clause 1, any other suitable clause, or any combination of suitable clauses, wherein the retractor comprises a distal end, a proximal end, and a middle portion between the distal end and the proximal end.
11. The retractor apparatus of clause 10, any other suitable clause, or any combination of suitable clauses, wherein the middle portion is adjustable so that it does not extend past the distal end or the proximal end.
12. The retractor apparatus of clause 10, any other suitable clause, or any combination of suitable clauses, wherein the distal end is rigid.
13. The retractor apparatus of clause 10, any other suitable clause, or any combination of suitable clauses, wherein the distal end comprises a metal, a polymer, or a combination thereof.
14. The retractor apparatus of clause 10, any other suitable clause, or any combination of suitable clauses, wherein the distal end is malleable.
15. The retractor apparatus of clause 10, any other suitable clause, or any combination of suitable clauses, wherein the distal end is shaped.
16. The retractor apparatus of clause 1, any other suitable clause, or any combination of suitable clauses, wherein the retractor is configured for movement using one hand of an operator.
17. The retractor apparatus of clause 1, any other suitable clause, or any combination of suitable clauses, wherein the retractor comprises a proximal end comprising a connection composition.
18. The retractor apparatus of clause 17, any other suitable clause, or any combination of suitable clauses, wherein the connection composition is configured for attachment to a ring.
19. The retractor apparatus of clause 18, any other suitable clause, or any combination of suitable clauses, wherein the ring is present on a retractor case.
20. The retractor apparatus of clause 19, any other suitable clause, or any combination of suitable clauses, wherein the retractor comprises a suture retractor configured to couple with the ring.
21. The retractor apparatus of clause 18, any other suitable clause, or any combination of suitable clauses, wherein the connection composition is configured for attachment to the ring via the bottom portion of the ring.
22. The retractor apparatus of clause 18, any other suitable clause, or any combination of suitable clauses, wherein the connection composition is configured for engagement and disengagement from the ring.
23. The retractor apparatus of clause 17, any other suitable clause, or any combination of suitable clauses, wherein the connection composition comprises a peg.
24. The retractor apparatus of clause 17, any other suitable clause, or any combination of suitable clauses, wherein the connection composition comprises a rod.
25. The retractor apparatus of clause 17, any other suitable clause, or any combination of suitable clauses, wherein the connection composition comprises a notch.
26. The retractor apparatus of clause 17, any other suitable clause, or any combination of suitable clauses, wherein the connection composition comprises a clip.
27. The retractor apparatus of clause 17, any other suitable clause, or any combination of suitable clauses, wherein the connection composition comprises a locking mechanism.
28. The retractor apparatus of clause 17, any other suitable clause, or any combination of suitable clauses, wherein the connection composition is configured for coupling via mechanical means, electrical means, magnetic means, or any combination thereof.
29. The retractor apparatus of clause 17, any other suitable clause, or any combination of suitable clauses, wherein the connection composition is configured for coupling via mechanical means.
30. The retractor apparatus of clause 17, any other suitable clause, or any combination of suitable clauses, wherein the connection composition is configured for coupling via electrical means.
31. The retractor apparatus of clause 17, any other suitable clause, or any combination of suitable clauses, wherein the connection composition is configured for coupling via magnetic means.
32. The retractor apparatus of clause 31, any other suitable clause, or any combination of suitable clauses, wherein the magnetic means comprise one or more static magnets.
33. The retractor apparatus of clause 31, any other suitable clause, or any combination of suitable clauses, wherein the magnetic means comprise electromagnetic energy.
34. The retractor apparatus of clause 33, any other suitable clause, or any combination of suitable clauses, wherein the electromagnetic energy comprises use of an electrical current.
35. The retractor apparatus of clause 1, any other suitable clause, or any combination of suitable clauses, wherein the retractor comprises a distal end locking mechanism.
36. The retractor apparatus of clause 35, any other suitable clause, or any combination of suitable clauses, wherein the retractor comprises an engaging composition to control the distal end locking mechanism.
37. The retractor apparatus of clause 36, any other suitable clause, or any combination of suitable clauses, wherein the engaging composition comprises a button, a switch, a grip, or any combination thereof.
38. The retractor apparatus of clause 1, any other suitable clause, or any combination of suitable clauses, wherein the retractor is configured for movement using two hands of an operator.
39. The retractor apparatus of clause 38, any other suitable clause, or any combination of suitable clauses, wherein the retractor comprises a handle, a grip, or a combination thereof.
40. The retractor apparatus of clause 39, any other suitable clause, or any combination of suitable clauses, wherein the handle and/or the grip is placed on the superior portion of the distal end of the retractor.
41. The retractor apparatus of clause 1, any other suitable clause, or any combination of suitable clauses, wherein the retractor comprises one or more degrees of freedom.
42. The retractor apparatus of clause 41, any other suitable clause, or any combination of suitable clauses, wherein the retractor comprises one degree of freedom.
43. The retractor apparatus of clause 41, any other suitable clause, or any combination of suitable clauses, wherein the retractor comprises two degrees of freedom.
44. The retractor apparatus of clause 41, any other suitable clause, or any combination of suitable clauses, wherein the retractor comprises three degrees of freedom.
45. The retractor apparatus of clause 41, any other suitable clause, or any combination of suitable clauses, wherein the retractor comprises four degrees of freedom.
46. The retractor apparatus of clause 41, any other suitable clause, or any combination of suitable clauses, wherein the retractor comprises five degrees of freedom.
47. The retractor apparatus of clause 41, any other suitable clause, or any combination of suitable clauses, wherein the retractor comprises six degrees of freedom.
48. The retractor apparatus of clause 1, any other suitable clause, or any combination of suitable clauses, wherein the retractor comprises six or more degrees of freedom.
49. The retractor apparatus of clause 1, any other suitable clause, or any combination of suitable clauses, wherein the retractor comprises soft robotics.
50. The retractor apparatus of clause 1, any other suitable clause, or any combination of suitable clauses, wherein the retractor comprises one or more cable driven joints.
51. The retractor apparatus of clause 1, any other suitable clause, or any combination of suitable clauses, wherein the retractor comprises one or more spring mechanisms.
52. The retractor apparatus of clause 1, any other suitable clause, or any combination of suitable clauses, wherein the retractor comprises one or more rack and pinion compositions.
53. The retractor apparatus of clause 1, any other suitable clause, or any combination of suitable clauses, wherein the retractor comprises one or more electromagnetic mechanisms.
54. The retractor apparatus of clause 1, any other suitable clause, or any combination of suitable clauses, wherein the retractor comprises one or more electrical mechanisms.
55. The retractor apparatus of clause 54, any other suitable clause, or any combination of suitable clauses, wherein the retractor comprises an electrical locking mechanism capable of engaging and/or disengaging the position of the retractor.
56. The retractor apparatus of clause 1, any other suitable clause, or any combination of suitable clauses, wherein the retractor comprises one or more buttons to engage and/or disengage movement in isolated planes.
57. The retractor apparatus of clause 1, any other suitable clause, or any combination of suitable clauses, wherein the retractor comprises one or more switches to engage and/or disengage movement in isolated planes.
58. The retractor apparatus of clause 1, any other suitable clause, or any combination of suitable clauses, wherein the retractor comprises one or more locking mechanisms to engage and/or disengage movement in isolated planes.
59. The retractor apparatus of clause 1, any other suitable clause, or any combination of suitable clauses, wherein the retractor comprises one or more grips.
60. The retractor apparatus of clause 59, any other suitable clause, or any combination of suitable clauses, wherein the grips comprise material for increasing coefficient of friction.
61. The retractor apparatus of clause 1, any other suitable clause, or any combination of suitable clauses, wherein the retractor comprises one or more intervals configured to comprise suture material.
62. The retractor apparatus of clause 61, any other suitable clause, or any combination of suitable clauses, wherein the interval comprises a mechanism configured to hold the suture material.
63. The retractor apparatus of clause 62, any other suitable clause, or any combination of suitable clauses, wherein the mechanism comprises means for holding selected from the group consisting of a clamp, a notch, friction, and any combination thereof.
64. A retractor case comprising an inner ring, an outer ring, and one or more surgical instruments.
65. The retractor case of clause 64, any other suitable clause, or any combination of suitable clauses, wherein the retractor case is configured to contact to a theater bubble.
66. The retractor case of clause 65, any other suitable clause, or any combination of suitable clauses, wherein the contact between the retractor case and the theater bubble is an airtight seal.
67. The retractor case of clause 65, any other suitable clause, or any combination of suitable clauses, wherein the contact is via a magnetic interaction.
68. The retractor case of clause 65, any other suitable clause, or any combination of suitable clauses, wherein the contact is via the inner ring.
69. The retractor case of clause 65, any other suitable clause, or any combination of suitable clauses, wherein the contact is via the outer ring.
70. The retractor case of clause 64, any other suitable clause, or any combination of suitable clauses, wherein the retractor case is configured to contact to an operating tent.
71. The retractor case of clause 70, any other suitable clause, or any combination of suitable clauses, wherein the contact between the retractor case and the operating tent is an airtight seal.
72. The retractor case of clause 70, any other suitable clause, or any combination of suitable clauses, wherein the contact is via a magnetic interaction.
73. The retractor case of clause 70, any other suitable clause, or any combination of suitable clauses, wherein the contact is via the inner ring.
74. The retractor case of clause 70, any other suitable clause, or any combination of suitable clauses, wherein the contact is via the outer ring.
75. The retractor case of clause 64, any other suitable clause, or any combination of suitable clauses, wherein the inner ring is configured for 360 degree rotation.
76. The retractor case of clause 64, any other suitable clause, or any combination of suitable clauses, wherein the inner ring is configured for placement of one or more retractor apparatuses.
77. The retractor case of clause 76, any other suitable clause, or any combination of suitable clauses, wherein the retractor apparatus is the retractor apparatus of any one of clauses 1 to 63.
78. The retractor case of clause 76, any other suitable clause, or any combination of suitable clauses, wherein the configuration comprises one or more notches.
79. The retractor case of clause 64, any other suitable clause, or any combination of suitable clauses, wherein the inner ring is configured for connection to a strap.
80. The retractor case of clause 79, any other suitable clause, or any combination of suitable clauses, wherein the strap comprises one or more buckles.
81. The retractor case of clause 79, any other suitable clause, or any combination of suitable clauses, wherein the inner ring comprises one or more holes or pegs configured to connect to the strap via one or more buckles.
82. The retractor case of clause 79, any other suitable clause, or any combination of suitable clauses, wherein the strap is an electrosurgery ground pad.
83. The retractor case of clause 79, any other suitable clause, or any combination of suitable clauses, wherein the strap is an electrocautery ground pad.
84. The retractor case of clause 64, any other suitable clause, or any combination of suitable clauses, wherein the outer ring is configured for 360 degree rotation.
85. The retractor case of clause 64, any other suitable clause, or any combination of suitable clauses, wherein the outer ring is configured for connection to a strap.
86. The retractor case of clause 85, any other suitable clause, or any combination of suitable clauses, wherein the strap comprises one or more buckles.
87. The retractor case of clause 85, any other suitable clause, or any combination of suitable clauses, wherein the inner ring comprises one or more holes or pegs configured to connect to the strap via one or more buckles.
88. The retractor case of clause 85, any other suitable clause, or any combination of suitable clauses, wherein the strap is an electrosurgery ground pad.
89. The retractor case of clause 85, any other suitable clause, or any combination of suitable clauses, wherein the strap is an electrocautery ground pad.
90. The retractor case of clause 64, any other suitable clause, or any combination of suitable clauses, wherein the inner ring, the outer ring, or both are electrically powered.
91. The retractor case of clause 90, any other suitable clause, or any combination of suitable clauses, wherein the electric power comprises a battery.
92. The retractor case of clause 90, any other suitable clause, or any combination of suitable clauses, wherein the electric power comprises a rechargeable battery.
93. The retractor case of clause 90, any other suitable clause, or any combination of suitable clauses, wherein the electric power comprises a portable battery.
94. The retractor case of clause 90, any other suitable clause, or any combination of suitable clauses, wherein the electric power comprises a car battery.
95. The retractor case of clause 90, any other suitable clause, or any combination of suitable clauses, wherein the electric power comprises a connection to a 120 volt outlet.
96. The retractor case of clause 90, any other suitable clause, or any combination of suitable clauses, wherein the electric power comprises a connection to a 220 volt outlet.
97. The retractor case of clause 90, any other suitable clause, or any combination of suitable clauses, wherein the electric power comprises a connection to a 240 volt outlet.
98. The retractor case of clause 90, any other suitable clause, or any combination of suitable clauses, wherein the electric power comprises a single circuit.
99. The retractor case of clause 90, any other suitable clause, or any combination of suitable clauses, wherein the electric power comprises a multi-circuit.
100. The retractor case of clause 90, any other suitable clause, or any combination of suitable clauses, wherein the inner ring and/or the outer ring comprises an inferior portion comprising an interface for grounding.
101. The retractor case of clause 100, any other suitable clause, or any combination of suitable clauses, wherein the interface comprises an electric lead.
102. The retractor case of clause 100, any other suitable clause, or any combination of suitable clauses, wherein the interface comprises a pad.
103. The retractor case of clause 64, any other suitable clause, or any combination of suitable clauses, wherein the inner ring, the outer ring, or both are optionally sealed with a lid.
104. The retractor case of clause 103, any other suitable clause, or any combination of suitable clauses, wherein the lid comprises a metal, a polymer, or a combination thereof.
105. The retractor case of clause 64, any other suitable clause, or any combination of suitable clauses, wherein the retractor case comprises a container for inclusion of the inner ring, the outer ring, and the surgical instruments.
106. The retractor case of clause 105, any other suitable clause, or any combination of suitable clauses, wherein the container comprises a top portion that is sealable.
107. The retractor case of clause 105, any other suitable clause, or any combination of suitable clauses, wherein the container comprises a bottom portion that is sealable.
108. The retractor case of clause 105, any other suitable clause, or any combination of suitable clauses, wherein the container is air-tight.
109. The retractor case of clause 105, any other suitable clause, or any combination of suitable clauses, wherein the container is configured for sterilization of the surgical instruments.
110. The retractor case of clause 105, any other suitable clause, or any combination of suitable clauses, wherein the container comprises a lumen.
111. The retractor case of clause 111, any other suitable clause, or any combination of suitable clauses, wherein the lumen is configured for injection of a sterilizing fluid.
112. The retractor case of clause 111, any other suitable clause, or any combination of suitable clauses, wherein the sterilizing fluid comprises a liquid comprising tetraglycine hydroperiodide tablets, trichloroisocyanuric acid tablets, chlorine dioxide tablets, a liquid comprising iodine tablets, a betadine solution, a chlorhexidine solution, or any combination thereof.
113. The retractor case of clause 112, any other suitable clause, or any combination of suitable clauses, wherein the container comprises a suction mechanism.
114. The retractor case of clause 112, any other suitable clause, or any combination of suitable clauses, wherein the container comprises a fluid removal mechanism.
115. The retractor case of clause 64, any other suitable clause, or any combination of suitable clauses, wherein the retractor case is capable of 360 degree rotation.
116. The retractor case of clause 64, any other suitable clause, or any combination of suitable clauses, wherein the retractor case is capable of expansion into an ellipse shape.
117. The retractor case of clause 116, any other suitable clause, or any combination of suitable clauses, wherein the retractor case is configured for collapse.
118. The retractor case of clause 64, any other suitable clause, or any combination of suitable clauses, wherein the retractor case is configured for housing within an external holding device.
119. The retractor case of clause 118, any other suitable clause, or any combination of suitable clauses, wherein the external holding device is a casing.
120. The retractor case of clause 118, any other suitable clause, or any combination of suitable clauses, wherein the external holding device is a bag.
121. The retractor case of clause 118, any other suitable clause, or any combination of suitable clauses, wherein the external holding device comprises air-tight sealing of the retractor case.
122. The retractor case of clause 121, any other suitable clause, or any combination of suitable clauses, wherein the external holding device is configured for primary sterilization.
123. The retractor case of clause 118, any other suitable clause, or any combination of suitable clauses, wherein the external holding device is resealable.
124. The retractor case of clause 118, any other suitable clause, or any combination of suitable clauses, wherein the external holding device is capable of one or more cycles of sterilization.
125. The retractor case of clause 124, any other suitable clause, or any combination of suitable clauses, wherein the sterilization comprises chemical sterilization, thermal sterilization, electrical sterilization, electromagnetic, radiation sterilization, UV sterilization, IR sterilization, X-ray sterilization, Gamma sterilization, or any combination thereof.
126. The retractor case of clause 64, any other suitable clause, or any combination of suitable clauses, wherein the retractor case comprises a film positioned between the inner ring and the outer ring.
127. The retractor case of clause 126, any other suitable clause, or any combination of suitable clauses, wherein the film overlays a procedural field of the retractor case.
128. The retractor case of clause 126, any other suitable clause, or any combination of suitable clauses, wherein the film is adhesive.
129. The retractor case of clause 126, any other suitable clause, or any combination of suitable clauses, wherein the film is sterilized.
130. The retractor case of clause 126, any other suitable clause, or any combination of suitable clauses, wherein the film comprises a sterilizing agent.
131. The retractor case of clause 130, any other suitable clause, or any combination of suitable clauses, wherein the sterilizing agent is betadine.
132. The retractor case of clause 126, any other suitable clause, or any combination of suitable clauses, wherein the film is configured to be adhered to skin.
133. The retractor case of clause 126, any other suitable clause, or any combination of suitable clauses, wherein the film is configured to be perforated.
134. The retractor case of clause 64, any other suitable clause, or any combination of suitable clauses, wherein the retractor case further comprises a strap.
135. The retractor case of clause 134, any other suitable clause, or any combination of suitable clauses, wherein the strap comprises one or more buckles.
136. The retractor case of clause 134, any other suitable clause, or any combination of suitable clauses, wherein the strap is configured to connect to the inner ring or the outer ring.
137. The retractor case of clause 134, any other suitable clause, or any combination of suitable clauses, wherein the strap is an electrosurgery ground pad.
138. The retractor case of clause 134, any other suitable clause, or any combination of suitable clauses, wherein the strap is an electrocautery ground pad.
139. The retractor case of clause 64, any other suitable clause, or any combination of suitable clauses, wherein the retractor case comprises latex.
140. The retractor case of clause 64, any other suitable clause, or any combination of suitable clauses, wherein the retractor case comprises a thin elastic material.
141. The retractor case of clause 64, any other suitable clause, or any combination of suitable clauses, wherein the retractor case comprises one or more lights.
142. The retractor case of clause 141, any other suitable clause, or any combination of suitable clauses, wherein the light is a LED light.
143. The retractor case of clause 141, any other suitable clause, or any combination of suitable clauses, wherein the light is battery powered.
144. The retractor case of clause 141, any other suitable clause, or any combination of suitable clauses, wherein the light is coupled to the inner ring.
145. The retractor case of clause 141, any other suitable clause, or any combination of suitable clauses, wherein the light is coupled to the outer ring.
146. The retractor case of clause 64, any other suitable clause, or any combination of suitable clauses, wherein the retractor case comprises a display system.
147. The retractor case of clause 146, any other suitable clause, or any combination of suitable clauses, wherein the display system is configured to integrate into one or more holes or pegs in the retractor case.
148. The retractor case of clause 146, any other suitable clause, or any combination of suitable clauses, wherein the display system comprises a mechanical system comprising a clip, a magnet, Velcro, a ring, or any combination thereof.
149. The retractor case of clause 148, any other suitable clause, or any combination of suitable clauses, wherein the mechanical system is configured to hold one or more surgical instruments to the base of the display system.
150. The retractor case of clause 146, any other suitable clause, or any combination of suitable clauses, wherein the display system comprises one or more storage rings.
151. The retractor case of clause 150, any other suitable clause, or any combination of suitable clauses, wherein the storage ring is placed on an edge of the display system.
152. The retractor case of clause 150, any other suitable clause, or any combination of suitable clauses, wherein the storage ring is placed on a corner of the display system.
153. The retractor case of clause 150, any other suitable clause, or any combination of suitable clauses, wherein the storage ring is placed on the top of the display system.
154. The retractor case of clause 150, any other suitable clause, or any combination of suitable clauses, wherein the storage ring is placed on the bottom of the display system.
155. The retractor case of clause 146, any other suitable clause, or any combination of suitable clauses, wherein the display system comprises the one or more surgical instruments.
156. The retractor case of clause 155, any other suitable clause, or any combination of suitable clauses, wherein the surgical instruments are selected from the group consisting of scalpels, individual scalpel blades, scissors, clamps, forceps, retractors, and any combination thereof.
157. The retractor case of clause 146, any other suitable clause, or any combination of suitable clauses, wherein the display system is configured for rotation around the inner ring or the outer ring of the retractor case.
158. A surgical system comprising i) a theater bubble, ii) a retractor case, and iii) an operating tent.
159. The surgical system of clause 158, any other suitable clause, or any combination of suitable clauses, wherein the theater bubble comprises between 2 and 6 operator openings.
160. The surgical system of clause 159, any other suitable clause, or any combination of suitable clauses, wherein the operator openings are configured for insertion of hands of an operator.
161. The surgical system of clause 159, any other suitable clause, or any combination of suitable clauses, wherein the operator openings are configured for insertion of arms of an operator.
162. The surgical system of clause 159, any other suitable clause, or any combination of suitable clauses, wherein the operator openings are configured for insertion of a tool.
163. The surgical system of clause 162, any other suitable clause, or any combination of suitable clauses, wherein the tool is an electrical tool.
164. The surgical system of clause 162, any other suitable clause, or any combination of suitable clauses, wherein the tool is a suction tool.
165. The surgical system of clause 159, any other suitable clause, or any combination of suitable clauses, wherein the operator openings are sealable.
166. The surgical system of clause 158, any other suitable clause, or any combination of suitable clauses, wherein the retractor case is the retractor case of any one of clauses 64 to 157.
167. The surgical system of clause 158, any other suitable clause, or any combination of suitable clauses, wherein the operating tent comprises a clear tent.
168. The surgical system of clause 167, any other suitable clause, or any combination of suitable clauses, wherein the operating tent is configured to provide an air-tight seal between the retractor case and a patient body to form a surgical operating site.
169. The surgical system of clause 167, any other suitable clause, or any combination of suitable clauses, wherein the operating tent comprises a magnetic connecting ring to contact the retractor case.
170. The surgical system of clause 167, any other suitable clause, or any combination of suitable clauses, wherein the operating tent comprises an adhesive to contact to a patient body.
171. The surgical system of clause 158, any other suitable clause, or any combination of suitable clauses, wherein the operating tent comprises a flexible material.
172. The surgical system of clause 171, any other suitable clause, or any combination of suitable clauses, wherein the operating tent comprises a magnetic connecting ring to contact the retractor case.
173. The surgical system of clause 171, any other suitable clause, or any combination of suitable clauses, wherein the operating tent comprises an adhesive to contact to a patient appendage.
174. The surgical system of clause 171, any other suitable clause, or any combination of suitable clauses, wherein the operating tent comprises collapsible tubing.
175. The surgical system of clause 174, any other suitable clause, or any combination of suitable clauses, wherein the collapsible tubing comprises a first end and a second end.
176. The surgical system of clause 175, any other suitable clause, or any combination of suitable clauses, wherein the first end is sealed.
177. The surgical system of clause 175, any other suitable clause, or any combination of suitable clauses, wherein the second end is configured for insertion of a patient appendage.
178. The surgical system of clause 158, any other suitable clause, or any combination of suitable clauses, wherein the theater bubble is configured to contact to the retractor case.
179. The surgical system of clause 178, any other suitable clause, or any combination of suitable clauses, wherein the contact between the retractor case and the theater bubble is an airtight seal.
180. The surgical system of clause 178, any other suitable clause, or any combination of suitable clauses, wherein the contact is via a magnetic interaction.
181. The surgical system of clause 178, any other suitable clause, or any combination of suitable clauses, wherein the contact is via an inner ring of the retractor case.
182. The surgical system of clause 178, any other suitable clause, or any combination of suitable clauses, wherein the contact is via an outer ring of the retractor case.
183. The surgical system of clause 158, any other suitable clause, or any combination of suitable clauses, wherein the operating tent is configured to contact to the retractor case.
184. The surgical system of clause 183, any other suitable clause, or any combination of suitable clauses, wherein the contact between the retractor case and the operating tent is an airtight seal.
185. The surgical system of clause 183, any other suitable clause, or any combination of suitable clauses, wherein the contact is via a magnetic interaction.
186. The surgical system of clause 183, any other suitable clause, or any combination of suitable clauses, wherein the contact is via an inner ring of the retractor case.
187. The surgical system of clause 183, any other suitable clause, or any combination of suitable clauses, wherein the contact is via an outer ring of the retractor case.
188. A method of performing a surgical intervention on a patient, said method comprising use of one or more of i) a theater bubble, ii) a retractor case, and iii) an operating tent on the patient, wherein the surgical intervention is performed in an austere location.
189. The method of clause 188, any other suitable clause, or any combination of suitable clauses, wherein the i) a theater bubble, ii) a retractor case, and iii) an operating tent are comprised as the surgical system of any one of clauses 158 to 187.
190. The method of clause 188, any other suitable clause, or any combination of suitable clauses, wherein the austere location is a military location.
191. The method of clause 188, any other suitable clause, or any combination of suitable clauses, wherein the austere location is a recreational wilderness medicine location.
192. The method of clause 188, any other suitable clause, or any combination of suitable clauses, wherein the austere location is a disaster location.
193. The method of clause 188, any other suitable clause, or any combination of suitable clauses, wherein the austere location is a rural location.
194. The method of clause 188, any other suitable clause, or any combination of suitable clauses, wherein the austere location is in space.

### EXAMPLES

### Example 1

### Exemplary Application of Surgical System

The instant example provides an exemplary use of the surgical system to provide immediate and effective invasive surgical care in an austere environment to stabilize a critically injured patient.

The injured patient can be evaluated to identify life-threatening injuries, prioritizing those requiring immediate intervention. For instance, the severity of a patient wound can be assessed, in particular attention to bleeding, vital signs, and the need for urgent surgical intervention.

The surgical system can be retrieved and placed on a stable surface. The operator can open the external holding container, ensuring the sterilization of the components. Thereafter, the operator can cleanse the patient wound site with the provided sterilizing solution. The patient can be positioned appropriately, ensuring stability and accessibility to the wound site.

The operator can unfold the retractor case with the folded display unit, straps, and disposable supplies. Then, the retractor case support can be applied to the appropriate surgical site, securing it in place with the straps. The display system can be deployed, exposing multiple surgical instruments for use.

The operator can utilize the surgical instruments, retractors, and other supplies to address the specific surgical needs, following established medical procedures. Thereafter, the operator can monitor patient vital signs and make real-time decisions regarding the continuation or sealing of the retractor case based on the patient's condition.

Upon completing the surgical intervention, the operator can close the retractor case and fold the display system back into place, securing the surgical system. The patient can be transported to a medical facility for further assessment and treatment.

The external holding container of the surgical system can be closed, ensuring all instruments and the display system are securely stored. The surgical system can be cleaned and sterilized for future use, following the provided instructions.

### Example 2

### Sterilization Efficiency Evaluation of the Surgical System

The instant example provides analysis of the sterilization efficiency of the surgical system. This study can determine the optimal combination of cleaning method and sterilization method to reduce bacterial growth within the surgical system using currently approved agents as well as agents commonly available in austere scenarios.

Autoclaved 10×10×1 mm surgical stainless-steel squares can be inoculated with 100 uL sterile saline or 100 uL of E. coli (laboratory strain) in concentrations ranging from 1000 cells/mL to 1×10⁷ cells/mL in a biosafety cabinet (BSC). The squares can then either be allowed to dry at room temperature in the BSC, rinsed with 1 mL of pure sterile water, or rinsed with 1 mL of pure sterile water containing soap. These squares can then be divided into treatment groups (10 per inoculation and rinsing method) for the remainder of the study.

Treatments can include autoclaving, one or more sterilization agents in the surgical system, or pure water placed in the invasive procedure. These transfers can be conducted in a BSC and ocellated on a rocking platform for 1 hour. The squares from each invasive procedure can be removed and placed in 10 mL LB broth in sterile culture tubes and then placed in a 37° C. incubator. Samples (100 uL) from each tube can be taken at 0, 1, 6, and 12 hours of incubation and bacterial growth can be assessed by optical density (with direct cell counts as an alternate method).

### Example 3

### Usability Evaluation of the Surgical System

The instant example provides usability evaluation of the surgical system and its ability to sterilize surgical tools in a real-world simulation. Surgical tools have numerous design aspects that impair the ability of cleaning agents from efficiently reaching all areas of the tool. In addition, different surgical methods and variations in surgeons can affect where and how contaminated each tool becomes.

Approximately five subjects can perform two separate simulated surgical procedures to evaluate the ability of the surgical system to render surgical tools sterile. The subjects cam perform both a resection of a portion of tendon and a vascular clamp of the major vein or artery from a raw porcine hoof. The procedures can each begin with a closed and sterile invasive procedure system containing one set of scissors, two sets of straight forceps, and two small tissue retractors. The skin of the practice tissue can be cleaned with a betadine solution approximately one minute prior to the start of the simulation. Subjects can use the kit to establish the surgical field and perform all required tasks so the simulation can be assessed for consistency. The control arm can use traditional surgical draping and tool storage. Times for each subject can be recorded from the point of surgical field establishment to their declared finish. This can be performed twice per subject per procedure.

The surgical tools can then be placed in the surgical system sterilization containers with either (select the approved surgical tool cleaning solution) or in pure sterile water and oscillated on a rocking platform for one hour. The invasive procedures can then be transferred to a BSC and cleaned with 70% ethanol prior to opening. The surgical tools can then be removed from each invasive procedure system and placed in a separate sealed sterile 500 ml beaker and 100 mL of LB broth will be added and agitated for one minute. The LB broth can then be transferred to a sterile culture flask for incubation at 37° C. The optical density of the culture can be measured at 0, 1, 6, and 12 hours of incubation. Additionally, samples of each broth can be retained for later limited analysis of bacterial diversity.

### Example 4

### Application of the Surgical System

The instant example provides assessment of an operator to deploy and perform an operation with the surgical system. A two-phased approach can be achieved, first using live animal subjects followed by human subjects.

For the initial animal studies, the operating room can be prepared and an anesthetized porcine subject can undergo an open bowel resection with anastomosis. Various outcomes can be assessed, for instance the setup times, number of instruments used, retractor adjustments, and procedure times. This procedure can serve as a control.

Thereafter, the same procedure can be performed using the using the surgical system. The same variables can be assessed and compared with control, as well as short- and long-term events such as surgical site infections, surgical complications, procedure success, and surgeon reviews and preferences.

Human subjects can undergo a similar setup as the animal studies. A surgical procedure that is commonly performed as an open procedure can be chosen for ease of patient requirements (for example, lipoma removal, inguinal hernia repairs, saphenous vein harvesting, limb amputations, and the like).

1. A retractor case comprising an inner ring, an outer ring, and one or more surgical instruments.

2. The retractor case of claim 1, wherein the retractor case is configured to contact to a theater bubble.

3. The retractor case of claim 2, wherein the contact is via a magnetic interaction.

4. The retractor case of claim 1, wherein the retractor case is configured to contact to an operating tent.

5. The retractor case of claim 4, wherein the contact is via a magnetic interaction.

6. The retractor case of claim 1, wherein the inner ring is configured for placement of one or more retractor apparatuses.

7. The retractor case of claim 1, wherein the inner ring is configured for connection to a strap.

8. The retractor case of claim 1, wherein the outer ring is configured for connection to a strap.

9. The retractor case of claim 1, wherein the retractor case comprises a container for inclusion of the inner ring, the outer ring, and the surgical instruments.

10. The retractor case of claim 9, wherein the container is configured for sterilization of the surgical instruments.

11. The retractor case of claim 1, wherein the retractor case is configured for housing within an external holding device.

12. The retractor case of claim 11, wherein the external holding device is capable of one or more cycles of sterilization.

13. The retractor case of claim 1, wherein the retractor case further comprises a strap.

14. A surgical system comprising i) a theater bubble, ii) a retractor case, and iii) an operating tent.

15. The surgical system of claim 14, wherein the theater bubble comprises between 2 and 6 operator openings.

16. The surgical system of claim 15, wherein the operating tent comprises a clear tent configured to provide an air-tight seal between the retractor case and a patient body to form a surgical operating site.

17. The surgical system of claim 14, wherein the theater bubble is configured to contact to the retractor case.

18. The surgical system of claim 14, wherein the operating tent is configured to contact to the retractor case.

19. A method of performing a surgical intervention on a patient, said method comprising use of one or more of i) a theater bubble, ii) a retractor case, and iii) an operating tent on the patient, wherein the surgical intervention is performed in an austere location.

20. The method of claim 19, wherein the austere location is selected from the group consisting of a military location, a recreational wilderness medicine location, a disaster location, a rural location, and in space.
